(19) United States
(12) Patent Application Publication
(10) Pub. No.: US 2010/0181467 A1
(43) Pub. Date: Jul. 22, 2010

(54) Light-Proximity-Inertial Sensor Combination

(76) Inventor: Tom Chang, Los Altos, CA (US)

Correspondence Address: MCCRACKEN & FRANK LLP, 311 S. WACKER DRIVE, SUITE 2500, CHICAGO, IL, 60606, US

(21) Appl. No.: 12/690,595

(22) Filed: Jan. 20, 2010

Related U.S. Application Data
(60) Provisional application No. 61/205,190, filed on Jan. 20, 2009.

(51) Int. Cl. H01J 40/14; G01J 1/42; G01P 15/00

(52) U.S. Cl. 250/221; 73/514.01

(57) ABSTRACT

A sensor includes a proximity-light sensor configured to detect proximity of objects and ambient light conditions, an inertial sensor, and control circuitry coupled to the proximity-light sensor and the inertial sensor and configured to control the operation of the proximity-light sensor and the inertial sensor. The sensor further includes a substrate, wherein the proximity-light sensor, the inertial sensor, and the control circuitry are disposed on the substrate to form a single package.

### CROSS REFERENCE TO RELATED APPLICATIONS

This application claims the benefit of U.S. Provisional Patent Application No. 61/205,190 filed Jan. 20, 2009, which is incorporated by reference herein in its entirety.

### REFERENCE REGARDING FEDERALLY SPONSORED RESEARCH OR DEVELOPMENT

Not applicable

### SEQUENTIAL LISTING

Not applicable

### BACKGROUND OF THE INVENTION

1. Field of the Disclosure

The present disclosure relates to ambient light, proximity, and inertial sensors and, more particularly, to combinations of such sensors.

2. Background of the Disclosure

Electronic devices, such as smart phones, mobile internet devices, personal digital assistants, global positioning system navigation devices, personal computers or laptops with touch screens, kiosks, and various other types of electronic appliances, games, toys, etc. have been developed to incorporate sensors to provide better power management, improved user interfaces, and environmental awareness. Such sensors may include an ambient light sensor, a proximity sensor, and an inertial sensor, for example. An ambient light sensor can be used to adjust the brightness of a display back-light to accommodate for different lighting conditions. A proximity sensor can be used to turn off a display back-light and/or a touch-panel sensor to avoid unwanted triggering, such as, when a phone is held next to an ear of a user. An inertial sensor can be used, for example, to detect motion of an electronic device, e.g., a mobile device, to cause a display image to rotate when the electronic device is rotated. In another example, an inertial sensor can detect movement of an electronic device relative to a gravitational field and interpret such movement as an input to perform a certain function in a software application or electronic game.

However, the addition of various sensors into an electronic device increases the cost and complexity of such device. For example, the electronic device must incorporate input/output lines from each sensor and deal with priority, response time, and other computations that come with the increased number of sensors and input/output lines. Further, the electronic device may have tight space constraints that limit the placement and number of sensors that can be incorporated into the device.

### SUMMARY OF THE INVENTION

In one example, a sensor includes a proximity-light sensor configured to detect proximity of objects and ambient light conditions, an inertial sensor, and control circuitry coupled to the proximity-light sensor and the inertial sensor and configured to control the operation of the proximity-light sensor and the inertial sensor. The sensor further includes a substrate, wherein the proximity-light sensor, the inertial sensor, and the control circuitry are disposed on the substrate to form a single package.

### BRIEF DESCRIPTION OF THE DRAWINGS

FIG. 1 is a block diagram of a sensor according to an embodiment;

FIG. 2 is a block diagram of a sensor according to another embodiment;

FIG. 3 is a block diagram of a sensor according to yet another embodiment;

FIG. 4 is a block diagram of a sensor according to a further embodiment;

FIG. 5 is a diagrammatic cross-sectional view of a three-chip sensor according to an embodiment;

FIG. 6 is a diagrammatic plan view of the three-chip sensor of FIG. 5;

FIG. 7 is a diagrammatic cross-sectional view of a three-chip sensor according to another embodiment;

FIG. 8 is a diagrammatic plan view of the three-chip sensor of FIG. 7;

FIG. 9 is a diagrammatic cross-sectional view of a three-chip sensor according to yet another embodiment;

FIG. 10 is a diagrammatic plan view of the three-chip sensor of FIG. 9;

FIG. 11 is a diagrammatic cross-sectional view of a two-chip sensor according to an embodiment;

FIG. 12 is a diagrammatic plan view of the two-chip sensor of FIG. 11;

FIG. 13 is a diagrammatic cross-sectional view of a two-chip sensor according to another embodiment;

FIG. 14 is a diagrammatic plan view of the two-chip sensor of FIG. 13;

FIG. 15 is a diagrammatic cross-sectional view of a single-chip sensor according to an embodiment;

FIG. 16 is a diagrammatic plan view of the single-chip sensor of FIG. 15;

FIG. 17 is a diagrammatic cross-sectional view of a three-chip sensor packaged with a light source according to an embodiment;

FIG. 18 is a plan view of the three-chip sensor and light source of FIG. 17;

FIG. 19 illustrates an electrical block diagram of a three-chip sensor according to an embodiment;

FIG. 20 illustrates an electrical block diagram of a two-chip sensor according to an embodiment; and

FIG. 21 illustrates an electrical block diagram of a single-chip sensor according to an embodiment.

### DETAILED DESCRIPTION

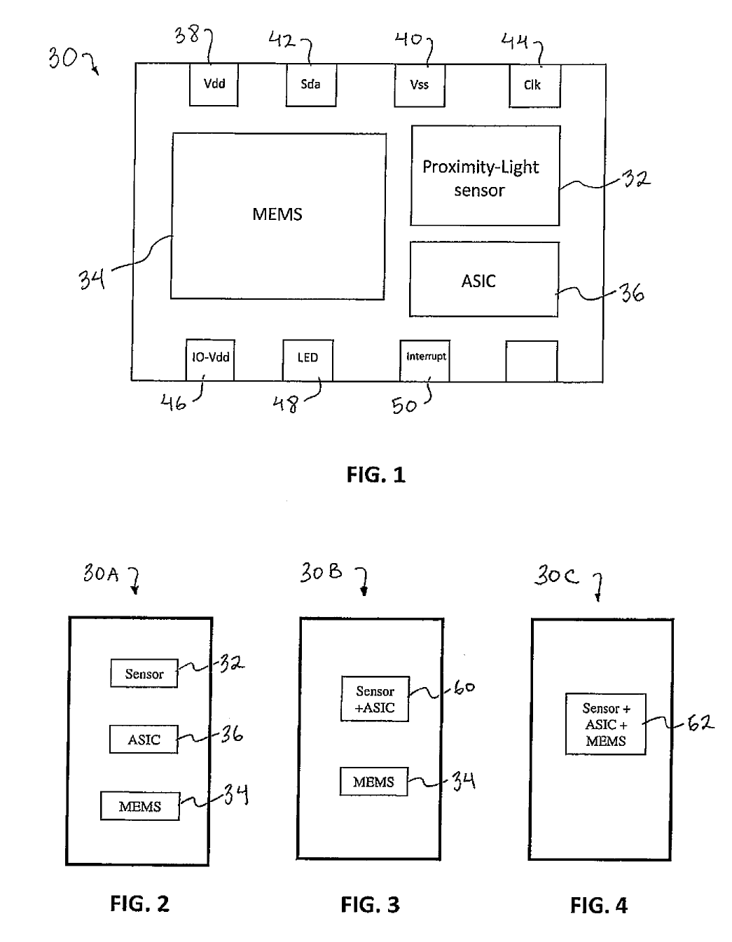

FIG. 1 illustrates a sensor 30 that integrates a proximity-light sensor 32, an inertial sensor 34, and control circuitry 36. The proximity-light sensor 32 can be any known sensor that is adapted to sense ambient light and proximity of an object, such as, a photonic detector CMOS integrated circuit. In one embodiment, the proximity-light sensor 34 is similar or identical to the sensors disclosed in U.S. Provisional Application No. 61/107,594 and U.S. patent application Ser. No. 12/220,578, each of which is incorporated by reference herein in its entirety. The inertial sensor 34 can be an accelerometer, a gyroscope, or any other known type of inertial sensor. In one example, the inertial sensor 34 is a microelectromechanical system (“MEMS”) device or, more specifically, the inertial sensor 34 can be a silicon MEMS inertial sensor. Further, the control circuitry 36 can include any suitable components to control the operation of the sensors and/or to act as a signal conditioner for the sensors. In one embodiment, the control circuitry 36 is an application specific integrated circuit (“ASIC”). Other modifications to the sensors 32, 34 and the control circuitry 36 can be made without departing from the spirit of the present disclosure.

The sensor 30 of FIG. 1 includes various power and input/output pins that can be shared by the sensors 32, 34 and the control circuitry 36 to reduce the total amount of pins that are needed to support all of the operations of the sensor 30. In one example, the chip includes a positive voltage supply pin 38, a negative voltage supply pin 40, one or more data input/output pins 42, a clock pin 44, an input/output supply voltage 46, a light emitting diode (“LED”) control pin 48, and an interrupt pin 50. However, in other embodiments, a fewer or greater number of the same or different pins can be used, as would be apparent to one of ordinary skill in the art.

The sensor 30 of FIG. 1 incorporates the functionality of an ambient light sensor, a proximity sensor, and an inertial sensor into a single package that requires fewer total pins, fewer input/output lines, has a reduced footprint, and a lower cost over separate sensors and control circuitry. Further, the integrated control circuitry 36 can operate the sensor and manage the priority of the various sensing functions internally without the need for extensive external control systems. In addition, the sensor 30 can be easily incorporated into existing electronic devices at a low cost and with minimal modifications to such devices because of the use of the integrated control circuitry 36.

In various embodiments, the sensor 30 of FIG. 1 is configured to sense light in a range from about 1 lux to about 30,000 lux, to provide accurate proximity sensing from about 0 to about 50 mm, to provide three-axis inertial sensing from about 0 g to about 3 g, and/or to provide angular positional and velocity sensing. Further, the sensor 30 can be programmed to interface with other devices via any suitable bus/protocol, such as, Inter-Integrated Circuit (“I²C”) or Serial Peripheral Interface (“SPI”), and can operate with a supply or input/output voltage in the range of about 1.2 V to about 3.6 V.

FIGS. 2-4 illustrate various embodiments of sensors 30A, 30B, 30C, respectively, that are capable of performing the same functions of the sensor 30 of FIG. 1 and are also configured in a single package. The sensors 30A-30C may include the same or different pins as described in relation to FIG. 1. The sensor 30A of FIG. 2 illustrates the general embodiment of FIG. 1, which includes three separate chips, i.e., a proximity-light sensor 32, a control ASIC 36, and a MEMS inertial sensor 34. The sensor 30B of FIG. 3 illustrates a single package that includes a chip 60 that incorporates a proximity-light sensor combined with a control ASIC and a separate MEMS inertial sensor 34. The sensor 30C of FIG. 4 illustrates a single package that includes a single chip 62 that integrates a proximity-light sensor, a control ASIC, and a MEMS inertial sensor. In one example, the size of the sensor 30A of FIG. 2 is about 6 mm by about 4 mm by about 1 mm, the size of the sensor 30B of FIG. 3 is about 4 mm by about 4 mm by about 1 mm, and the size of the sensor 30C of FIG. 4 is about 3 mm by about 3 mm by about 1 mm. However, in other embodiments, the packaging and design of the sensors can be modified as would be apparent to one of skill in the art.

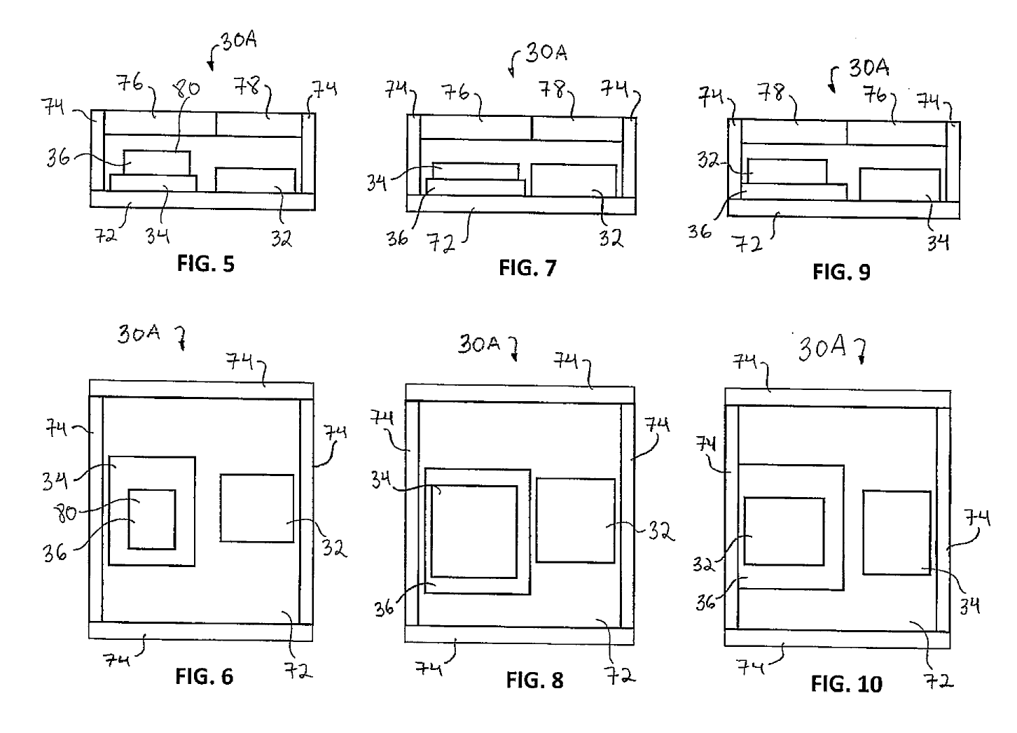

Referring now to FIGS. 5-10, various embodiments of the sensor 30A of FIG. 2 are illustrated that include a separate proximity-light sensor 32, control ASIC 36, and MEMS inertial sensor 34 disposed upon a substrate 72. The substrate can be any suitable printed circuit board material, such as, flame retardant 4 (“FR-4”), BT-Epoxy, and the like. More specifically, the sensor 30A of FIGS. 5 and 6 includes the MEMS inertial sensor 34 and the proximity-light sensor 32 disposed adjacent one another directly on the substrate 72 and the control ASIC 36 disposed over the MEMS inertial sensor 34. The sensor 30A of FIGS. 7 and 8 includes the control ASIC 36 and the proximity-light sensor 32 disposed adjacent one another directly on the substrate 72 and the MEMS inertial sensor 34 disposed over the control ASIC 36. Further, the sensor 30A of FIGS. 9 and 10 includes the control ASIC 36 and the MEMS inertial dispenser 34 disposed adjacent one another directly on the substrate and the proximity-light sensor 32 disposed over the control ASIC 36. As is apparent from the embodiments of FIGS. 5-10, various arrangements of the proximity-light sensor 32, the control ASIC 36, and the MEMS inertial sensor 34 are contemplated in the present disclosure. However, the proximity-light sensor 32 should generally be placed in a position so that light will impinge upon a light detector portion of the sensor 32. Consequently, the proximity-light sensor 32 can be a top or upper layer of the sensor 30 or can be placed by itself without other light-blocking components disposed thereon or with light-blocking components disposed thereon but not disposed in a position that prevents light from reaching the light detector portion.

The sensors 30 of FIGS. 5-10 or any of the other sensors or chips disclosed herein can be bonded to or otherwise include enclosures to protect the sensors/chips from external mechanical damage. In FIGS. 5-10, the sensors 30 further include side enclosures 74 that extend upwardly from the substrate 72 around a periphery of the sensor 30. In one embodiment, the side enclosures 74 are made from an opaque material to shield light-sensitive components of the sensor. For example, the control ASIC 36 may be sensitive to light and an opaque packaging 80 (see, e.g., FIGS. 5 and 6) may be applied to the control ASIC 36 to prevent transistor noise induced by light. The sensors 30 further include a top enclosure 76 that can also be made from an opaque material. In the embodiments of FIGS. 5-10, the top enclosure 76 can further include a transparent window 78 that is disposed over the proximity-light sensor 32 to allow light to impinge upon the sensor 32. In one embodiment, the transparent window 78 can be an optical component, such as, a lens, reflector, mirror, light guide, diffuser, collimator, polarizer, beam splitter, and the like, to improve or modify the light detecting capabilities of the sensor 32.

In one embodiment, the entire top enclosure 76 is made transparent and opaque shielding is applied over the control ASIC 36. In one example, the opaque shielding comprises a top metal layer of the ASIC 36. In another example, an epoxy with a dark pigment is molded over the control ASIC 36. The opaque shielding may be applied to other light sensitive portions of the sensor 70, for example, portions of the proximity-light sensor 32, excluding a light detector portion.

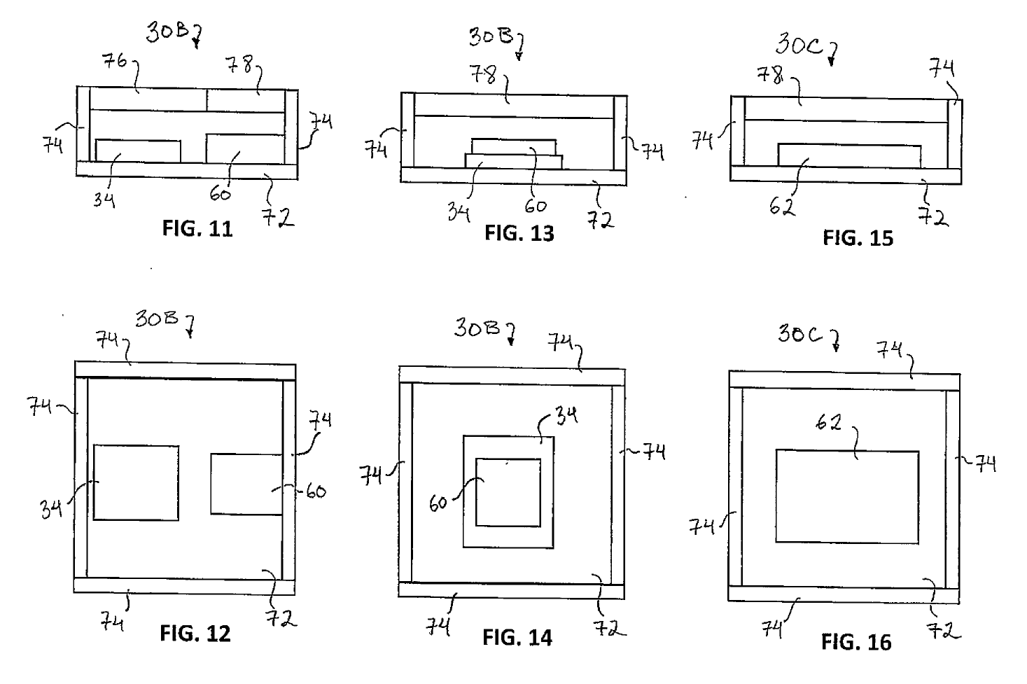

FIGS. 11-14 illustrate various embodiments of the sensor 30B of FIG. 3 that include the chip 60, which integrates the proximity-light sensor 32 and the control ASIC 36, and a separate MEMS inertial sensor 34. The sensor 30B of FIGS. 11 and 12 includes the chip 60 and the MEMS inertial sensor 34 disposed adjacent one another on the substrate 72. Further, the sensor 30B of FIGS. 11 and 12 includes side enclosures 74 and a top enclosure 76 with a transparent window 78 disposed over the chip 60. The sensor 30B of FIGS. 13 and 14 includes the MEMS inertial sensor 34 disposed on the substrate 72 and the chip 60 disposed over the MEMS inertial sensor 34. In the present embodiment, the sensor 30B of FIGS. 13 and 14 also includes side enclosures 74 and a transparent top enclosure or window 78 over the chip 60.

FIGS. 15 and 16 illustrate an example of the sensor 30C of FIG. 4 that includes the single chip 62, which incorporates the proximity-light sensor 32, the control ASIC 36, and the MEMS inertial sensor 34. In the present embodiment, the sensor 30C further includes side enclosures 74 and a transparent top enclosure or window 78.

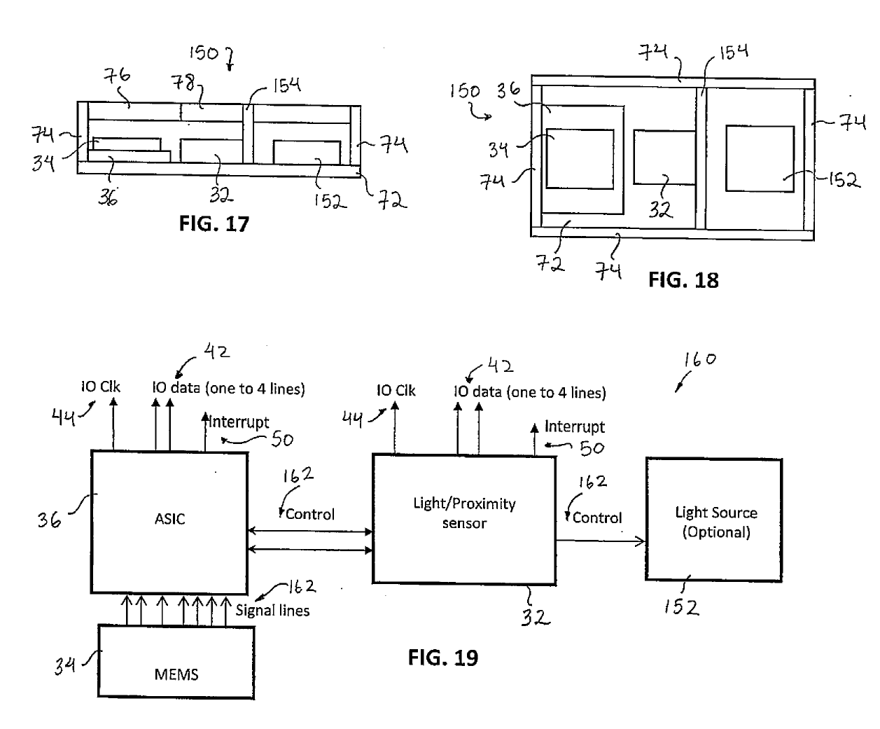

FIGS. 17 and 18 illustrate examples of a sensor 150 that is packaged with a light source 152. More specifically, FIGS. 17 and 18 illustrate the sensor 30A of FIGS. 7 and 8 packaged with the light source 152 in a separate compartment with an opaque wall 154 disposed therebetween. However, in other embodiments, the light source 152 can be configured into a single chip with any of the sensor configurations disclosed herein. The light source 152 can be used as an indicator light and/or can be used in combination with the proximity-light sensor 32 to detect proximity. In one example, the light source 152 is used in combination with the proximity-light sensor 32, wherein light emitted by the light source 152 and reflected back to the proximity-light sensor 32 is processed by the control circuitry 36 to detect proximity of an object. The control circuitry 36 can process the light reflected back to the proximity-light sensor 32 using time-of-flight techniques and/or by examining the reflected light intensity to detect proximity. The light source can emit light in any suitable range or ranges of wavelengths, e.g., in visible light wavelengths to function as an indicator light or in infrared wavelengths to function in combination with the proximity-light sensor 32 to detect proximity. Other modifications to the light source 152 and the functioning thereof can be made, as would be apparent to one of ordinary skill in the art.

FIGS. 19-21 illustrate various electrical block diagrams 160, 170, 180, respectively, that can be used in combination with the various sensors disclosed herein. More particularly, the block diagram 160 of FIG. 19 illustrates an embodiment similar to the sensors 30, 30A of FIGS. 1 and 2, for example, that includes three separate chips, a proximity-light sensor 32, a control ASIC 36, and a MEMS inertial sensor 34. Further, the block diagram 160 may include an optional light source 152, as described above in relation to FIGS. 17 and 18. In the present embodiment, the block diagram 160 also includes input/output clocks 44, input/output data lines or pins 42, and interrupt lines or pins 50 coupled to the various components of the block diagram. Various signal and/or control lines 162 couple the proximity-light sensor 32, the control ASIC 36, the MEMS inertial sensor 34, and the light source 152 to each other, as would be apparent to one of skill in the art.

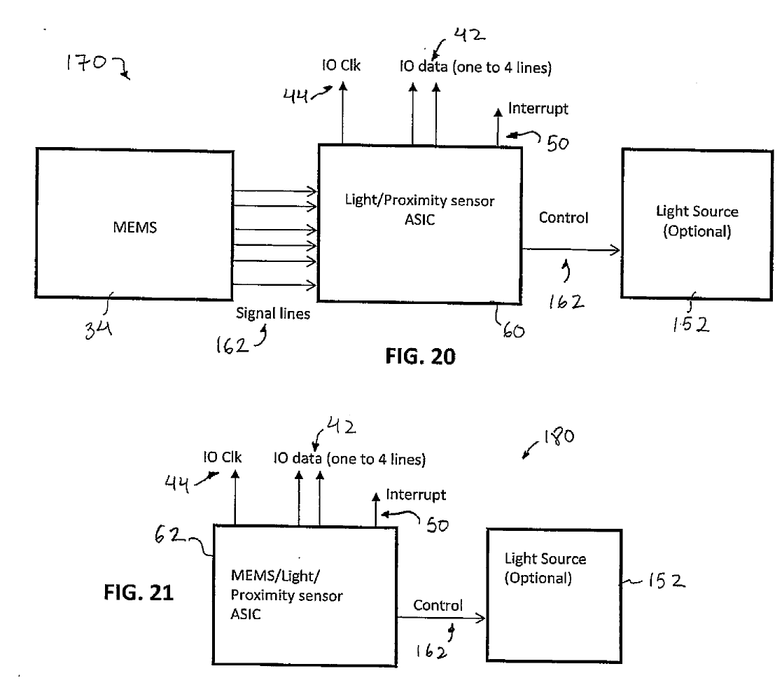

Referring to FIG. 20, the block diagram 170 illustrates an embodiment similar to the sensor 30B of FIG. 3, for example, that includes a chip 60, which incorporates a proximity-light sensor combined with a control ASIC, and a separate MEMS inertial sensor 34. In the present embodiment, the block diagram 170 also includes an optional light source 152, input/output clocks 44, input/output data lines or pins 42, and interrupt lines or pins 50 coupled to the various components of the block diagram. Various signal and/or control lines 162 couple the chip 60, the MEMS inertial sensor 34, and light source 152 to each other, as would be apparent to one of skill in the art.

Referring to FIG. 21, the block diagram 180 illustrates an embodiment similar to the sensor 30C of FIG. 4, for example, that includes a chip 62, which integrates a proximity-light sensor, a control ASIC, and a MEMS inertial sensor. In the present embodiment, the block diagram 180 also includes an optional light source 152, input/output clocks 44, input/output data lines or pins 42, and interrupt lines or pins 50 coupled to the various components of the block diagram. One or more signal and/or control lines 162 couple the chip 62 and the light source 152 together, as would be apparent to one of skill in the art.

Various modifications to the embodiments of FIGS. 19-21 can be made without departing from the spirit of the present disclosure, as would be apparent to those of skill in the art.

Further, other embodiments of the disclosure including all the possible different and various combinations of the individual features of each of the foregoing described embodiments are specifically included herein.

### INDUSTRIAL APPLICABILITY

The sensors disclosed herein are configured to perform the functions of an ambient light sensor, a proximity sensor, and an inertial sensor in a single integrated package. Such sensors can be used in a wide variety of electronic devices, e.g., smart phones, computers with touch screens, kiosks, etc. Generally speaking, the cost of sensor packaging is a major component of the overall cost of the sensor. The sensors disclosed herein incorporate multiple chips into a single package to reduce the total cost of having multiple sensing functions. Further, the sensors disclosed herein provide various combinations of proximity, ambient light, motion, gravitational field direction, and/or rotation sensing functions to enable new applications and improved user interaction with electronic devices. Having such various functions in a single package allows new applications to be easily developed and characterized at the module level and provides a “turn-key” solution for electronic device designers/programmers.

Numerous modifications to the present disclosure will be apparent to those skilled in the art in view of the foregoing description. Accordingly, this description is to be construed as illustrative only and is presented for the purpose of enabling those skilled in the art to make and use the disclosure and to teach the best mode of carrying out the same. The exclusive right to all modifications within the scope of this disclosure is reserved.

We claim:

1. A sensor, comprising:
a proximity-light sensor configured to detect proximity of objects and ambient light conditions;
an inertial sensor;
control circuitry coupled to the proximity-light sensor and the inertial sensor and configured to control the operation of the proximity-light sensor and the inertial sensor; and
a substrate, wherein the proximity-light sensor, the inertial sensor, and the control circuitry are disposed on the substrate to form a single package.

2. The sensor of claim 1, wherein the package further includes one or more supply voltage pins, one or more input/output pins, and a clock pin.

3. The sensor of claim 1, wherein the proximity-light sensor is a single integrated chip.

4. The sensor of claim 1, wherein the proximity-light sensor is configured on the substrate to allow light to impinge thereupon.

5. The sensor of claim 4, wherein the proximity-light sensor is disposed directly on the substrate.

6. The sensor of claim 5, wherein the proximity-light sensor is disposed adjacent to the inertial sensor and the control circuitry, and wherein the inertial sensor and the control circuitry are stacked one upon the other.

7. The sensor of claim 1, further comprising side enclosures that extend from the substrate around the proximity-light sensor, the inertial sensor, and the control circuitry to protect the package from mechanical damage.

8. The sensor of claim 7, further comprising a top enclosure disposed over the proximity-light sensor, the inertial sensor, and the control circuitry.

9. The sensor of claim 8, wherein the side and top enclosures are made from an opaque material to provide a light shield for light-sensitive components, and wherein the top enclosure further includes a transparent window to allow light to impinge on the proximity-light sensor.

10. The sensor of claim 1, further comprising a light shield applied over light-sensitive portions of the package.

11. The sensor of claim 10, wherein the light shield is an opaque shielding applied over the control circuitry.

12. The sensor of claim 1, wherein the package is about 6 mm by about 4 mm by about 1 mm in size.

13. The sensor of claim 1, wherein the proximity-light sensor and the control circuitry are integrated into a single chip.

14. The sensor of claim 13, wherein the single proximity-light sensor and control circuitry chip is disposed on top of the inertial sensor on the substrate, and further comprising side enclosures that extend from the substrate around the single chip and the inertial sensor and a top enclosure disposed over the single chip and the inertial sensor, wherein the side and top enclosures are made from an opaque material to provide a light shield for light-sensitive components, and wherein the top enclosure further includes a transparent window to allow light to impinge on the single chip.

15. The sensor of claim 13, wherein the package is about 4 mm by about 4 mm by about 1 mm in size

16. The sensor of claim 1, wherein the proximity-light sensor, the inertial sensor, and the control circuitry are integrated into a single chip.

17. The sensor of claim 16, further comprising side enclosures that extend from the substrate around the single proximity-light sensor, inertial sensor, and control circuitry chip and a top enclosure disposed over the single chip, wherein the side enclosures are made from an opaque material to provide a light shield for light-sensitive components and the top enclosure includes a transparent window to allow light to impinge on the single chip.

18. The sensor of claim 16, wherein the package is about 3 mm by about 3 mm by about 1 mm in size.

19. The sensor of claim 1, further comprising a light source disposed on the substrate within the single package.

20. The sensor of claim 19, further comprising an opaque wall disposed between the light source and the proximity-light sensor, the inertial sensor, and the control circuitry.
